(19) United States
(12) Patent Application Publication
(10) Pub. No.: US 2016/0353263 A1
(43) Pub. Date: Dec. 1, 2016

(54) METHOD AND SYSTEM FOR ACTIVELY PROVIDING INFORMATION BASED ON POSITION

(71) Applicant: Winitech Co., Ltd., Daegu (KR)

(72) Inventor: Kyo Koan CHU, Daegu (KR)

(21) Appl. No.: 14/743,863

(22) Filed: Jun. 18, 2015

(30) Foreign Application Priority Data
May 27, 2015 (KR) 10-2015-0074140

(51) Int. Cl. H04W 4/22; H04W 4/02; H04W 4/06

(52) U.S. Cl. CPC H04W 4/22; H04W 4/06; H04W 4/02

(57) ABSTRACT

A method and system for providing indoor emergency alert is provided. An indoor emergency alert system obtains, from a user terminal, identification of an accessible beacon that is installed in a subspace of a building. The system recognizes identification of the subspace of the building corresponding to the identification of beacon obtained from the user terminal. Using the recognized identification of the subspace, the system maintains association between the subspace and the user terminal. When an emergency occurs at the building, the system can transmit a subspace-specific alert message to the user terminal based on the association between the subspace and the user terminal.

### CROSS REFERENCE TO RELATED APPLICATION

The present application claims priority from Korean Patent Application Number 10-2015-0074140 filed on 27 May, 2015, the entire contents of which are incorporated herein for all purposes by this reference.

### BACKGROUND

Field of the Invention

The present invention relates to a method and system for actively providing information based on a position. More particularly, the present invention relates to a method and system able to actively provide suitable information based on a position within a subject space using a beacon.

Description of Related Art

Location based services (LBSs) using a user's location data by determining the position of a user terminal, such as a mobile phone, are widely used. Location based services generally locate user terminals using global positioning system (GPS) receivers. However, in many cases, indoor users may not be provided with continuous position information since it may be difficult to receive GPS satellite signals indoors.

A variety of technologies have been disclosed in order to determine an indoor position by overcoming this problem.

For example, a variety of services using beacons, radio transmitters able to emit a radio signal having a specific frequency, have been prominent. Such beacons can emit a radio signal having a low frequency using, for example, a protocol based on Bluetooth 4.0 (Bluetooth low energy (BLE)), and support high-speed radio communications while having a low level of power consumption. Such Bluetooth chipsets can have unique identification information (i.e. unique identification information identifying each device, for example, a universally unique identifier (UUID), a major value, a minor value, a media access control (MAC) address, or the like).

Hereinafter, the term “beacon” will be defined as referring to a radio signal emitter emitting the identification information thereof to a user terminal. It will be apparent to a person skilled in the art that the beacon may be embodied in a variety of forms.

Beacons can be identified based on the unique identification information thereof without pairing between devices, and can, in real time, send information to and receive information from user terminals. Due to such advantages, the use of beacons is rapidly increasing. In addition, indoor user positioning technologies using such a beacon have been disclosed.

Examples thereof include Korean Patent Nos. 10-1283896 (FIRE DETECTOR INCLUDING BEACON MODULE FOR INDOOR POSITIONING, EVACUATION GUIDANCE LAMP, AND INDOOR POSITIONING SYSTEM USING THE SAME) and 10-1241793 (FLUORESCENT LAMP SOCKET CONNECTOR HAVING INDOOR POSITIONING BEACON MODULE AND INDOOR POSITIONING SYSTEM USING THE SAME), both granted to the applicant.

However, these technologies of the related art are only used for the determining of the position of users, and fail to adaptively and actively provide information (e.g. information for evacuation in an emergency) to users. In particular, conventionally, there is neither a connectional relationship between the beacon and a subspace (i.e. a subspace included in an indoor space) nor information about the connection, since such beacons may be disposed in arbitrary positions within the indoor space. Therefore, only a service, such as the providence of information based on the position of the beacon, has been performed, and no service, such as providing information based on subspaces, has been provided.

In addition, conventionally, such beacons have only emitted radio signals in a passive manner. In some cases, proper information may not be provided thereby in an emergency (e.g. in the case of the collapse of a building or during a communications disruption between a server side and the user terminal).

### BRIEF SUMMARY

Various aspects of the present invention provide a method and system for providing a space-based service by mapping beacons and predetermined subspaces while determining positions using the beacons. Also provided is a method and system able to identify a subspace using a uniform resource locator (URL) such that information about the subspace can be universally acquired in an emergency, whereby prompt action can be taken.

Also provided is a method and system for allowing a beacon to actively provide necessary information to a user in an emergency as well as a rescue operation to be performed using the beacon.

According to an aspect of the present invention, an indoor emergency alert system is disclosed. In an environment where a building includes a plurality of subspaces, the system can maintain a database that stores hierarchy and/or locations of subspaces inside the building. For each of the subspaces inside the building, one or more beacons can be installed. The system maintains a database that stores association between identification of a subspace and identification of one or more beacons which corresponds to (installed at) the subspace. The system can also maintain a database that stores association between a subspace and a device located at the subspaces. The association between a subspace and a device can be maintained and updated using beacon information reported by the device. The system can determine that a device is located at a specific subspace when the device reports identification of a beacon associated with the specific subspace, and accordingly associate identification of the device and identification of the specific subspace.

The system obtains information regarding an emergency at a building. The obtained information includes various information about the emergency including type, location, current status, expectation of the emergency and other factors that may affect progress of the emergency. Using the obtained information, the system can identify a target subspace (floor, room, and/or aisle) of the building that is currently or will be affected by the emergency. Using identification of the target subspace, the system can refer to a database for retrieving identification of a target device that is associated with the identification of the target subspace. Because the association between the target device and the target space subspaces has been updated using identification of beacon reported by the target device as being accessible/detectable, the system can identify the target device that is located at the target subspace. The system can automatically generate an alert message using information about target subspace as well as information about the emergency. The system can transmit the generated alert message to the target device that is determined to be located at the target subspace.

According to another aspect of the present invention, an URL can be assigned to each of subspaces of a building. For each of the URL assigned to subspaces, the indoor emergency alert system provides a webpage where emergency information (status, progress, etc.) of a corresponding subspace is provided. While generating an alert message for a target device, the system can include an URL assigned to a target subspace associated with the target device for providing subspace-specific information, for example, guide for evacuation from the target subspace.

According to an aspect of the present invention, a method of actively providing information based on a position includes: receiving, at a service system, identification information of a communications beacon of a plurality of beacons disposed in a subject space from a user terminal, the communications beacon communicating with the user terminal; recognizing, at the service system, identification information of a subspace of the subject space corresponding to a user based on the identification information of the communications beacon; specifying, at the service system, subject information corresponding to the recognized identification information of the subspace; and transmitting, at the service system, the specified subject information to the user terminal.

According to another aspect of the present invention, a system for actively providing information based on a position stores: identification information of a plurality of subspaces of a subject space; and identification information of a beacon corresponding to each of the plurality of subspaces or space information of each of the plurality of subspaces, wherein the identification information of the plurality of subspaces is expressed as uniform resource locators (URLs).

According to further another aspect of the present invention, a system for actively providing information based on a position includes: a beacon communicating with a user terminal; a communications module emitting a radio signal including identification information of the beacon; memory storing preset subject information based on a position in which the beacon is disposed; and a control module directly transmitting the subject information stored in the memory to the user terminal through the communications module when communications with the user terminal are enabled.

According to another aspect of the present invention, a system for actively providing information based on a position includes: a beacon communicating with a user terminal; a communications module emitting a radio signal including identification information of the beacon; memory; and a control module storing communications history information including user identification information corresponding to the user terminal in the memory when communications with the user terminal are enabled.

According to yet another aspect of the present invention, a system for actively providing information based on a position includes: a communications portion receiving identification information of a communications beacon of a plurality of beacons disposed in a subject space from a user terminal, the communications beacon communicating with the user terminal; a space recognizing portion recognizing identification information of a subspace of the subject space corresponding to a user based on the identification information of the communications beacon; a controlling portion specifying subject information corresponding to the recognized identification information of the subspace, and transmitting the specified subject information to the user terminal.

According to embodiments of the invention, a subject space is divided into a plurality of subspaces, and a plurality of beacons is mapped to the plurality of subspaces, such that services can be rapidly and accurately provided based on the subspaces instead of the positions of the beacons. It is therefore possible to provide services based on the subspaces considering information about the subspaces (e.g. the shapes and positions of the subspaces, the connectional relationships of the subspaces to another space, and the like) instead of providing services based on the positions of the beacons to which information about relatively-narrow areas is mapped.

In addition, the subspaces are identified with URLs, general-purpose identification information, which are not limited information that only the servicing side can recognize. Accordingly, anyone can rapidly obtain information about a corresponding subspace and use the obtained information in a rescue operation.

Furthermore, each beacon not only passively functions to emit a radio signal including the identification information thereof for the purpose of indoor positioning, but also actively provides necessary information to a user terminal during a communications disruption between the terminal and the server side that would occur in an emergency. In this manner, efficient services can be provided.

In addition, the beacon is configured to store therein the communications history between the user terminal and the beacon, such that the communications history stored in the beacon can be used as reference information in a rescue operation.

### BRIEF DESCRIPTION OF THE DRAWINGS

A brief description is given for the enhancement of understanding of the accompanying drawings, in which:

FIG. 1 is a schematic diagram illustrating a system configuration embodying a method of actively providing information based on a position according to an exemplary embodiment of the present invention;

FIG. 2 is a schematic configuration diagram illustrating the service system embodying the method of actively providing information based on a position according to an exemplary embodiment of the present invention;

FIG. 3 is a schematic configuration diagram illustrating the beacon embodying the method of actively providing information based on a position according to an exemplary embodiment of the present invention;

FIG. 4 is a diagram explaining a subspace according to an exemplary embodiment of the present invention;

FIG. 5 is a diagram explaining effects in the case in which the identification information of the subspace is expressed as a URL according to an exemplary embodiment of the present invention;

FIG. 6 is a diagram explaining the concept by which the beacon directly provides subject information to the user terminal according to an exemplary embodiment of the present invention; and

FIG. 7 is a diagram explaining the concept in which the beacon stores a communications history about communications with the user terminal according to an exemplary embodiment of the present invention.

### DETAILED DESCRIPTION

The present invention has other advantages associated with the operation of the present invention and objects that are realized by the practice of the present invention which will be apparent from, or are set forth in greater detail in the accompanying drawings, which are incorporated herein, and in the following Detailed Description of the present invention, which together serve to explain certain embodiments of the present invention.

Herein, it will be understood that, when an element is referred to as “transmitting” a data to another element, the element not only can directly transmit the data to another element but also indirectly transmit the data to another element via at least one intervening element. In contrast, when an element is referred to as “directly transmitting” a data to another element, the element can transmit the data to another element without an intervening element.

Exemplary embodiments of the present invention will now be described more fully hereinafter with reference to the accompanying drawings. Reference should be made to the drawings, in which the same reference numerals and signs are used throughout the different drawings to designate the same or similar components.

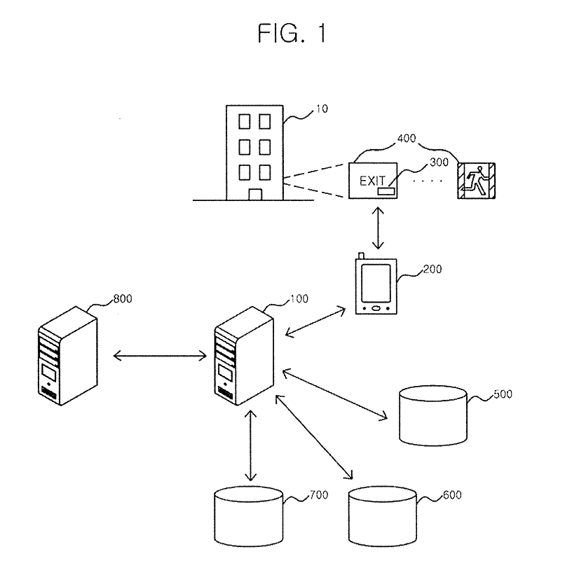

FIG. 1 is a schematic diagram illustrating a system configuration embodying a method of actively providing information based on a position according to an exemplary embodiment of the present invention.

Referring to FIG. 1, a service system 100 is provided in order to embody the method of actively providing information based on a position according to an embodiment of the present invention. The service system 100 can implement an embodiment of the present invention while communicating with a user terminal 200.

The user terminal 200 may refer to a terminal of a user who will consume information provided from the service system 100. Although the user terminal 200 is illustrated as a mobile phone in FIG. 1, the user terminal 200 may be any device (e.g. a personal digital assistant (PDA), a smartwatch, a notebook computer, or the like) that can process data while communicating with the service system 100 in order to implement an embodiment of the present invention.

The user terminal 200 communicates with a beacon 300 according to embodiments of the present invention. The user terminal 200 transmits necessary information to and receive necessary information from the beacon 300 via wireless communications. For example, the user terminal 200 and the beacon 300 perform Bluetooth communications. However, this is not intended to be limiting, and the user terminal 200 and the beacon 300 can perform communications using any wireless communications protocol able to be applied for embodiments of the present invention.

The beacon 300 emits a radio signal including the identification information thereof at a predetermined period. In addition, the beacon 300 according to embodiments of the present invention directly transmits a piece of subject information to the user terminal 200 to be described hereinafter.

The subject information according to the present invention may be evacuation information (e.g. an evacuation map, an indoor map, or the like) that may help a user safely escape from a subject space 10. However, this is not intended to be limiting. For example, the subject information may be any type of information, such as a piece of text, an image, or a video image, for providing an advertisement or a service according to subspaces in ordinary times. In an emergency, the subject information may be emergency-related information regarding a disaster including the evacuation information. In addition, different types of information may be provided to the user terminal (e.g. the user terminal 200) from the beacon (e.g. the beacon 300) and/or the service system 100 in ordinary times. Although reference will now be made to a case in which the subject information is evacuation information provided to the user in an emergency, the scope of the present invention is not limited thereto.

The subject information may be information that is previously stored in memory of the beacon 300. In addition, the subject information may be information that is preset based on the position in which the beacon 300 is disposed. The subject information may indicate information to the user according to the position in which the beacon 300 is disposed. For example, the subject information may include evacuation information necessary for the user to evacuate or escape a space in an emergency. For example, the evacuation information may include an evacuation map or an indoor map. In addition, the evacuation information may include text information detailing actions required of the user in an emergency.

Since the beacon 300 is configured to directly emit the subject information to the user terminal 200 in this manner, it is at least possible to actively provide the preset subject information to the user in a situation in which communications between the user terminal 200 and the service system 100 are impossible in an emergency, although the subject information is not updated in real time according to an emergency situation.

In addition, the beacon 300 according to an embodiment of the present invention stores communications history information about the history of communications with at least one terminal (e.g. the user terminal 200). The communications history information includes at least information about the history of the final communications between the user terminal 200 and the beacon 300. That is, the communications history information includes the identification information of the terminal that communicated with the beacon 300 during the last proper operation of the beacon 300. In some implementations, the communications history information may include a communications time, the number of terminals that communicated with the beacon 300, and the like.

The communications history information may include all information about the terminal that communicated with the beacon 300 (e.g. terminal identification information, a communications time, or the like). It is preferable that the communications history information include information about the terminal during the last proper operation (e.g. within a predetermined period of time from a point in time at which the beacon 300 started failing to properly function, within a period in which a radio signal is emitted, or the like). Since the communications history information is stored in the memory of the beacon 300, the beacon 300 can be a key clue for providing information for a rescue operation in an emergency situation, for example, in which a life-saving operation is required. Information about the user (e.g. the identification information of the beacon with which the user terminal 200 communicated, a communications time, or the like) may be stored on a servicing side (e.g. a user database (DB)) as will be described later. However, since communications between the user terminal 200 and the servicing side may not be properly performed, the communications history information collected through direct communications between the beacon 300 and the terminal may have a significant value regardless of information stored on the servicing side.

The beacon 300 is disposed in a predetermined position within the subject space 10. For example, the beacon 300 is disposed to correspond to a subspace of the subject space. The beacon 300 disposed to correspond to the subspace may indicate that the subspace to correspond to the beacon 300 is identified when the beacon 300 is identified.

For this, the beacon 300 is disposed in a predetermined position within the corresponding subspace. For example, the beacon 300 may be disposed in a predetermined device 400 (e.g. an exit sign, an evacuation guide light, or the like) present at a gate of the subspace or within the subspace. When the beacon 300 is disposed in the device 400, a variety of effects can be obtained. For example, the beacon 300 is constantly supplied with electric power. Descriptions of these effects will be omitted since they were disclosed in the Korean Patents as described above in the Description of the Related Art section.

When the subject space 10 is an indoor space, the subspaces may be divided according the building stories or may be blocks partitioned in a predetermined manner even if the subspaces are on the same building story. The subspaces may be divided according to the uses of the space (e.g. a corridor, a stairway, rooms, or the like). A space having a single use may be divided into a plurality of subspaces. In addition, the subspaces may be logically divided regardless of the physical division of the space. In any cases, according to an embodiment of the present invention, the beacon 300 may be disposed and/or managed to correspond to the subspace of the subject space 10. In addition, a plurality of beacons may correspond to a single subspace. In this case, discriminatory services can be provided to the user since the user terminal 200 can be more specifically positioned within one of the subspaces.

When the beacon 300 is managed to correspond to the subspace in this manner, it is possible to provide a service based on a subspace. Accordingly, the service can be more efficiently and rapidly provided than in the case in which a service is provided based on the position of the beacon 300. For example, when there is no corresponding relationship between the beacon 300 and the subspace, the position of the user must be determined based on the position of the beacon 300, and a service corresponding to the determined position must be provided. In addition, the type of the determined position must be determined by additional calculation or using space information (e.g. space modeling information). For this, the position should be determined using a plurality of the beacons 300. Accordingly, a complicated calculation process is required. However, when the corresponding relationship is set between the beacon 300 and the subspace according to the present embodiment, the subspace corresponding to the beacon 300 can be rapidly determined, and a service to be provided is determined based on the subspace. Accordingly, services can be provided very effectively and rapidly. This may be more effective when services are provided according to subspaces, i.e. relatively wide areas.

According to an embodiment of the present invention, the identification information for identifying the subspace may be expressed as a uniform resource locator (URL). The subspace can be identified with a URL, i.e. a type of general-purpose identification information. In this case, anyone who knows the identification information of a specific subspace can rapidly and easily acquire information about the specific subspace (e.g. 3D modeling information of the specific subspace). Accordingly, general-purpose services that are expandable can be build. For example, when the servicing side uses the identification information of the subspace defined by the servicing side, there is a problem in that the user cannot acquire information about the subspace using only the identification information without the cooperation of the servicing side. In an emergency, it may be essential to rapidly acquire information and respond. However, in some cases, the servicing side may not rapidly cooperate or the cooperation of the servicing side may be impossible. Therefore, when the identification information of the subspace is expressed as a URL, i.e. a type of general-purpose identification information, it is possible to rapidly and effectively access information.

For example, the service system 100 provides a page (e.g. a webpage, a mobile page, or the like), from which information about the corresponding subspace can be acquired, using the URL corresponding to the subspace. Therefore, according to an embodiment of the present invention, a person (e.g. a user trapped in the subspace 10, a rescuer, or the like) who acquired the identification information of the specific subspace in an emergency can rapidly acquire information about the specific subspace at any time.

The service system 100 can realize embodiments of the present invention through communications with a user database (DB) 500 maintaining/managing information about the user present in the subject space 10. In some implementations, the user DB 500 may be included in the service system 100.

Information about the user may be information with which the position of the user within the subject space 10 can be determined. For example, at every time when a user terminal, such as the user terminal 200, of a specific user communicates with at least one beacon disposed in the subject space 10, the service system 100 stores the identification information of the beacon (hereinafter referred to as the “communications beacon”) that communicated with the user terminal 200, user identification information corresponding to the user terminal 200 (e.g. the identification information of the user terminal 200, the identification information of an application installed in the user terminal 200, user ID, or the like), and/or information about a point in time at which the communications beacon 300 communicated with the user terminal 200 in the user DB 500. As information about users is maintained/managed in the user DB 500 in this manner, the service system 100 can selectively provide services to some of users in the subject space 10. For example, in an emergency, the service system 100 selects a user who may be damaged according to the situation of the emergency, and selectively provides the subject information to the selected user.

In addition, the service system 100 can realize embodiments of the present invention based on a beacon DB 700. In some implementations, the beacon DB 700 may be included in the service system 100.

The beacon DB 700 stores the identification information of the plurality of subspaces of the subject space 10 and the identification information of beacons corresponding to the plurality of subspaces. When the user terminal, such as the user terminal 200, communicates with a beacon, such as the beacon 300, the service system 100 receives the identification information of the beacon 300 (and the identification information of the user) from the user terminal 200. Thereafter, the service system 100 updates the user DB 500 based on the received information. In addition, the service system 100 acquires the identification information of the subspace corresponding to the beacon 300 from the beacon DB 700 based on the identification information of the beacon 300 from among the received information.

In addition, the service system 100 can realize embodiments of the present invention based on a space DB 600. In some implementations, the space DB 600 may be included in the service system 100.

The space DB 600 stores the identification information of the subspace and the subject information corresponding to the subspace. Alternatively, subspace-specific space information (e.g. 2D or 3D modeling information) is stored in the space DB 600. The space information may include information about the interior, shape, material properties, and openings (windows and doors) of the subspace, as well as information about topology with the other subspaces. The space information may be expressed as, for example, building information modeling (BIM) information, but this is not intended to be limiting. As described above, the service system 100 discloses the subspace-specific space information included in the space DB 600 on a page mapped to the identification information of the subspace.

The service system 100 receives emergency information from an emergency alert system 800. The emergency information may include information about the type of an emergency, a point in time in which the emergency occurred, and/or the position in the subject space 10 in which the emergency occurred. The emergency alert system 800 may be implemented as any type of data processing device that can receive information regarding the emergency from an external source and send the emergency information based on the received information about the disaster to the service system 100. In some implementations, the emergency alert system 800 may be included in the service system 100.

When the emergency information is received, the service system 100 recognizes the position, the point in time in which the emergency occurred, and/or the type of the emergency from the emergency information. Subsequently, the service system 100 specifies a subject user to be influenced by the emergency information based on the recognized information. The subject user to be influenced by the emergency information refers to the user who will be influenced by the emergency corresponding to the emergency information. The service system 100 recognizes the information about users stored in the user DB 500 in order to specify the subject user.

For example, when the information about the position in which the emergency occurred is recognized, the service system 100 specifies at least one subspace to be influenced by the emergency by referring to the space DB 600. The subspace to be influenced by the emergency may not only be a subspace to be directly influenced at a point in time in which the emergency occurs but also a subspace to be influenced later. The subspace to be influenced by the emergency may differ according to the type of the emergency (e.g. a fire, flooding, an electric leakage, or the like). The service system 100 specifies the subspace to be influenced by the emergency based on the type of the emergency, the position in which the emergency occurred, and the space information stored in the space DB 600. The service system 100 also specifies the subspace to be influenced by the emergency in a variety of methods based on the topology of the subspace included in the space information with respect to the other subspaces (e.g. connectional relationships, openings, or the like), the material properties of the subspace, and the like.

In addition, the service system 100 specifies a user positioned in the subspace to be influenced by the emergency as a subject user based on the information stored in the user DB 500 (e.g. user identification information, beacon identification information (or subspace identification information), and/or a communications time). Afterwards, the service system 100 transmits the subject information and/or the emergency information corresponding to the subspace in which the subject user is positioned to the user terminal of the subject user. In addition, the service system 100 may control a software (e.g. an application) installed in the user terminal of the subject user to output an alarm signal notifying the emergency.

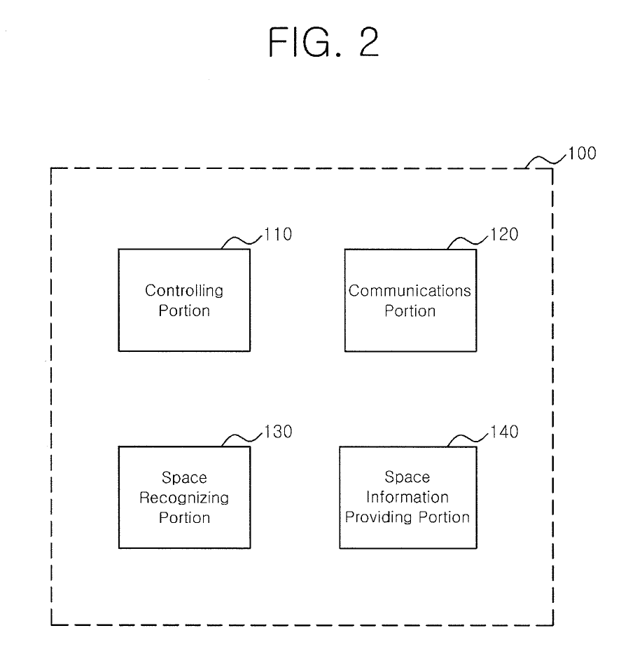

FIG. 2 is a schematic configuration diagram illustrating the service system embodying the method of actively providing information based on a position according to an exemplary embodiment of the present invention.

Referring to FIG. 2, the service system 100 according to the present embodiment includes a controlling portion 110, a communications portion 120, and a space recognizing portion 130. The service system 100 further includes a space information providing portion 140.

Here, the term “portion” or “module” refers to a functional and/or structural combination of hardware for embodiments of the present invention and software for enabling the hardware to operate. For example, each component expressed as the “portion” or “module” may indicate a logical unit of cods and hardware resources executing the codes. It is apparent to a person skilled in the art to which the present invention relates that the “portion” or “module” is not limited to physically-connected codes, one type of hardware, or a specific number of hardware components. Therefore, each of the components refers to a combination of hardware and software executing functions defined herein, but does not indicate a specific physical configuration.

Herein, the service system 100 is not necessarily a single physical device. The service system 100 may be configured such that a plurality of physical devices are organically combined for embodiments of the present invention. In some implementations, the plurality of physical devices may be spaced far apart from each other. In some cases, the plurality of physical devices of the service system 100 may be operated by different entities.

The service system 100 may be embodied using a variety of data processing devices, such as a processor capable of processing data, memory in which software for embodiments of the present invention is stored, and a network device networking with other devices. It is apparent to a person skilled in the art to which the present invention relates that embodiments of the present invention can be implemented by organically combining the software with the hardware of the service system 100.

The controlling portion 110 controls the other components' function and/or resources of the service system 100, such as the communications portion 120, the space recognizing portion 130, and the space information providing portion 140, embodiments of the present invention.

The communications portion 120 receives the identification information of a communications beacon from a user terminal (e.g. the user terminal 200), the communications beacon communicating with the user terminal 200. The communications portion 120 may further receive the user identification information of the user terminal 200. The user identification information may be ID of user terminal 200, the identification information of an application installed in the user terminal 200 for embodiments of the present invention and/or user ID.

The identification information of the communications beacon (e.g. the beacon 300) is included in a radio signal emitted from the communications beacon 300, and the user terminal (e.g. the user terminal 200) acquires the identification information of the communications beacon 300 by receiving the radio signal.

When the identification information of the beacon 300 and/or the user identification information corresponding to the user terminal 200 is received from the user terminal 200, the controlling portion 110 stores the received identification information of the beacon 300, the user identification information, and/or a communications time in the user DB 500.

The space recognizing portion 130 recognizes a subspace corresponding to the communications beacon 300 based on the identification information of the communications beacon 300. The recognition of the subspace may indicate the recognition of the identification information of the subspace. As described above, the space recognizing portion 130 recognizes the subspace corresponding to the communications beacon 300 by referring to the beacon DB 700. The identification information of a plurality of subspaces of the subject space 10 as well as the identification information of beacons corresponding thereto is previously stored in the beacon DB 700 in a corresponding manner.

Then, the controlling portion 110 specifies subject information corresponding to the recognized subspace. For this, the controlling portion 110 refers to the space DB 600, as described above. That is, subspace-specific identification information, subspace-specific subject information, and/or subspace-specific space information are previously stored in the space DB 600. In some implementations, a plurality of pieces of the subspace-specific subject information is previously stored in the space DB 600, and the controlling portion 110 specifies a suitable piece of subject information from among the plurality of pieces of subject information according to the type of an emergency. The controlling portion 110 specifies subject information corresponding to the recognized subspace, and subsequently transmits the specified subject information to the user terminal 200. Consequently, the subject information (e.g. evacuation information, such as an indoor map, an evacuation map, other pieces of information, or the like) is displayed by an application installed in the user terminal 200.

In addition, the controlling portion 110 receives emergency information from the emergency alert system 800 through the communications portion 120. The controlling portion 110 specifies a subspace to be influenced by an emergency through the space recognizing portion 130 and the space DB 600, based on information about a position in which the emergency occurred, a time in which the emergency occurred, the type of the emergency, or the like, the information being included in the emergency information.

Afterwards, the controlling portion 110 specifies a subject user through the user DB 500 based on the specified subspace, and subsequently transmits subject information corresponding to the position of the corresponding user and the emergency information to the user terminal of the specified user. (The subject information may be emergency-related information (or evacuation information) regarding a disaster.) In addition, the controlling portion 110 controls the user terminal of the subject user to output an alarm signal.

The space information providing portion 140 provides a page mapped to a plurality of subspace-specific URLs. The space information providing portion 140 may be implemented as a web server separate from the other components of the service system 100. The page mapped to the plurality of subspace-specific URLs includes space information of subspaces corresponding to the plurality of subspace-specific URLs. In some implementations, subject information may be further included for each of the subspaces. The space information providing portion 140 provides information included in the space DB 600 to the terminal through the page. Therefore, anyone who knows the identification information of a specific subspace can rapidly and easily acquire information about the specific subspace.

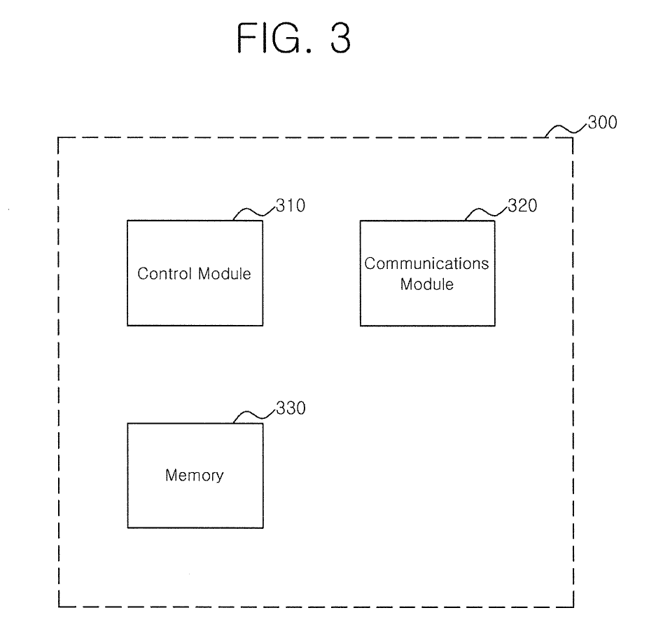

FIG. 3 is a schematic configuration diagram illustrating the beacon embodying the method of actively providing information based on a position according to an exemplary embodiment of the present invention.

Referring to FIG. 3, the beacon (e.g. the beacon 300) according to the present embodiment includes a control module 310, a communications module 320, and memory 330.

The control module 310 may be implemented as a processor controlling the other components of the beacon 300.

The communications module 320 communicates with the user terminal (e.g. the user terminal 200). For this, the communications module 320 periodically emits a radio signal including the identification information of the beacon 300. The communications module 320 may be implemented as a Bluetooth device, but this is not intended to be limiting.

The memory 330 may be implemented as any type of storage device capable of storing information. For example, the memory 330 may be a nonvolatile memory. Therefore, when the supply of power is stopped, information stored in the memory 330 can be acquired by a rescuer to serve as key data for a rescue operation.

Preset subject information is previously stored in the memory 330 based on a position in which the beacon 300 is disposed. The subject information set based on the position in which the beacon 300 is disposed may be a piece of subject information predefined according to the subspace corresponding to the beacon 300. Therefore, different pieces of subject information may correspond to different beacons.

The subject information is output from the service system 100 and is transmitted to the beacon 300 through the user terminal 200. In some implementations, the subject information may be previously input into the memory 330 when the beacon 300 is disposed in the subspace.

The control module 310 directly transmits the subject information stored in the memory 330 to the user terminal 200. The control module 310 may transmit the subject information stored in the memory 330 to the user terminal 200 as soon as communications are performed between the user terminal 200 and the beacon 300. In some implementations, the control module 310 may transmit the subject information at the request from the user terminal 200. For example, the application installed in the user terminal 200 periodically communicates with the service system 100. When communications with the service system 100 are disabled, the application controls the user terminal 200 to request the subject information from the beacon 300. Then, the control module 310 transmits the subject information to the user terminal 200 through the communications module 320.

The control module 310 stores communications history information including the user identification information of at least one terminal that communicates with the beacon 300 in memory 330. As described above, the communications history information may include at least information about the history of the last communication between the at least one terminal (e.g. the user terminal 200) and the beacon 300. That is, the communications history information includes the identification information of the terminal that communicated with the beacon 300 during the last proper operation of the beacon 300. In some implementations, the communications history information may include a communications time, the identification information of the user, the number of terminals that communicated with the beacon 300, or the like.

The control module 310 can store all information about the terminal that communicated with the beacon 300 (e.g. terminal identification information, a communications time, or the like) as the communications history information in the memory 330. Otherwise, it is preferable that the communications history information include at least information about the terminal during the last proper operation (e.g. within a predetermined period of time from a point in time at which the beacon 300 started failing to properly function, within a period in which a radio signal is emitted, or the like). It is preferable that the communications history information include information about the terminal during the last proper operation (e.g. within a predetermined period of time from a point in time at which the beacon 300 started failing to properly function, within a period in which a radio signal is emitted, or the like). Since the communications history information is stored in the memory of the beacon 300, the beacon 300 can be a key clue for providing information for a rescue operation in an emergency situation, for example, in which a life-saving operation is required. Information about the user (e.g. the identification information of the beacon with which the user terminal 200 communicated, a communications time, user identification information, or the like) may be stored on the user DB 500. However, since communications between the user terminal 200 and the servicing side may not be properly performed, the communications history information collected through direct communications between the beacon 300 and the terminal may have a significant value regardless of information stored on the servicing side. In other words, information about users stored in the user DB 500 may differ from the communications history information stored in the memory 330 depending on the situation and the speed of communications. In this case, the communications history information stored in the memory 330 of the beacon 300 can be more up-to-date than the information stored in the user DB 500 and consequently be used as important information in a rescue operation.

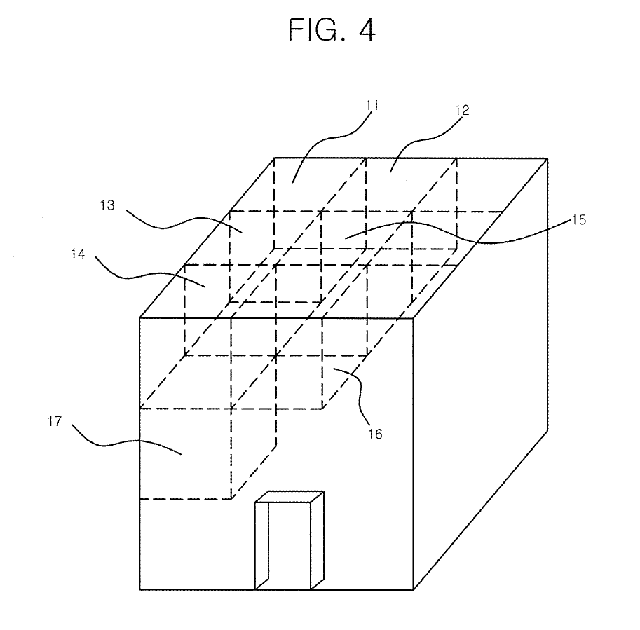

FIG. 4 is a diagram explaining the subspace according to an exemplary embodiment of the present invention.

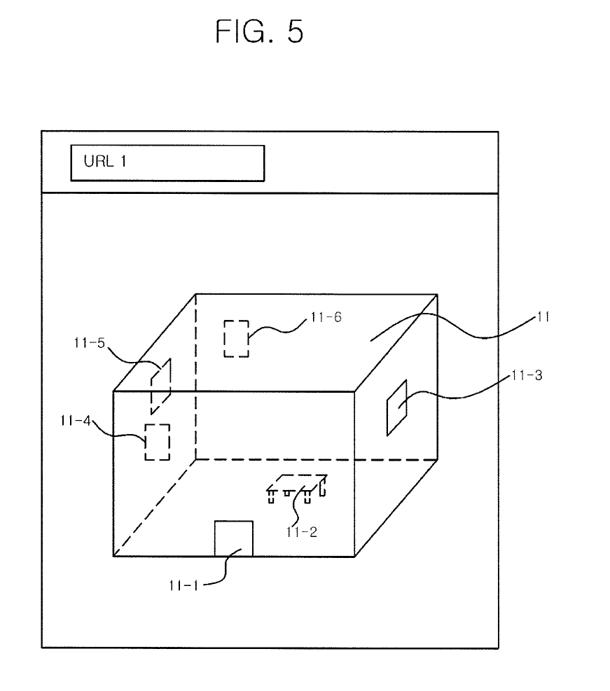

In addition, FIG. 5 is a diagram explaining effects in the case in which the identification information of the subspace is expressed as a URL according to an exemplary embodiment of the present invention.

First, referring to FIG. 4, the subject space 10 is divided into a plurality of subspaces (e.g. subspaces 11 to 17) for embodying the method of actively providing information based on a position according to an exemplary embodiment of the present invention.

Each of the plurality of subspaces 11 to 17 is set to correspond to at least one beacon (e.g. the beacon 300). When the identification information of the beacon 300 is recognized, the corresponding subspace can be determined.

The plurality of subspaces 11 to 17 is divided according to the physical properties of the space 10, as described above, or is logically divided according to the service purposes of the service system 100. The subspaces may be divided according to the uses of the space. As described above, the subspaces may be divided by a variety of methods.

Each of the plurality of subspaces 11 to 17 has identification information. The identification information of each of the plurality of subspaces 11 to 17 is expressed by a URL. For example, the subspace 11 has URL 1 as identification information thereof, and the subspace 2 has URL 2 as identification information thereof. The other subspaces have identification information expressed as URLs in the same manner.

Referring to FIG. 5, the URL, i.e. the identification information of each of the plurality of subspaces, is mapped to predetermined page. For example, it is possible to easily access the page through the URL 1, the identification information of the subspace 11. The page includes the space information of the subspace 11 corresponding to the URL 1. A user (e.g. a rescuer, a person in charge of a rescue operation, a person to be rescued, or the like) can recognize the space information provided on the page, as illustrated in FIG. 5. For example, the space information of the subspace 11 is recognized on the page mapped to the identification information of the subspace 11. The user can recognize the positions and/or the sizes of the exit 11-1 and windows or other openings 11-3, 11-4, 11-5 and 11-6 of the subspace 11. The user can also recognize an object 11-2 or other pieces of equipment present within the subspace 11.

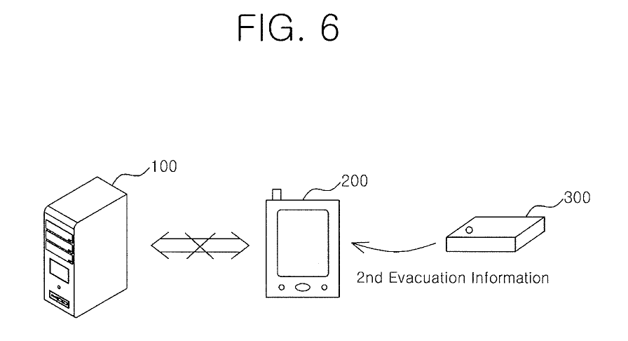

FIG. 6 is a diagram explaining the concept by which the beacon directly provides subject information to the user terminal according to an exemplary embodiment of the present invention.

Referring to FIG. 6, as described above, the user terminal (e.g. the user terminal 200) receives subject information from the service system 100 or receives subject information previously-stored in the beacon (e.g. the beacon 300) from the beacon 300. During a communications disruption between the user terminal 200 and the service system 300, available subject information can be obtained from at least the beacon 300 even if the subject information is not up-to-date.

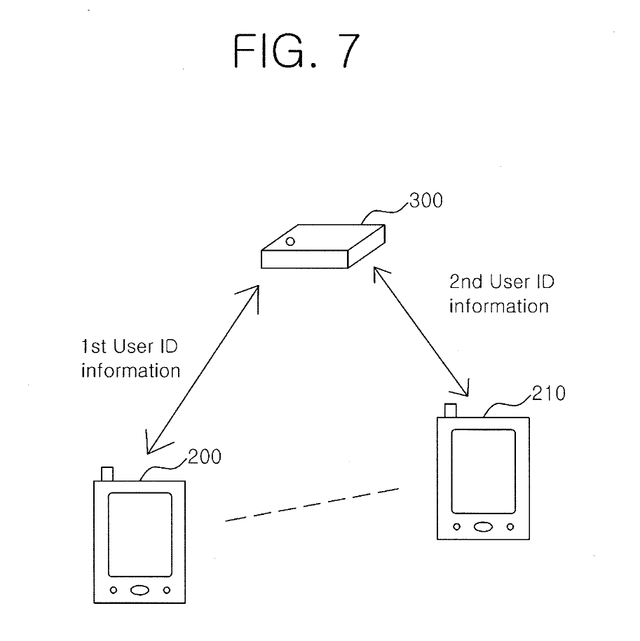

FIG. 7 is a diagram explaining the concept in which the beacon stores a communications history about communications with the user terminal according to an exemplary embodiment of the present invention.

Referring to FIG. 7, as described above, the beacon (e.g. the beacon 300) stores and/or manages the communications history information of a terminal that communicates therewith. The communications history information includes user identification information (e.g. first user identification information and second user identification information) corresponding to at least terminals (e.g. the user terminal 200 and a terminal 210) that communicated with the beacon 300. In some implementations, the beacon 300 may further store information about a communications time.

The beacon 300 may store and maintain the user identification information of only several terminals that were most recently stored, or store and/or maintain all the user identification information of all terminals that communicated therewith. It is preferable that the user identification information of a certain number of terminals that recently communicated with the beacon 300 be maintained as the communications history information in the beacon 300. The communications history information indicates that the beacon 300 stores and/or maintains the most recent communications information (information about the situations and/or positions of users) during the proper operation thereof. Therefore, it is possible to obtain the beacon 300 and use the communications history information stored therein as key information in a rescue operation.

The method of actively providing information based on a position according to an embodiment of the present invention may be embodied as computer readable codes stored in a computer readable recording medium. The computer readable recording medium includes all sorts of record devices in which data readable by a computer system are stored. Examples of the computer readable recording medium include read only memory (ROM), random access memory (RAM), compact disc read only memory (CD-ROM), a magnetic tape, a hard disk, a floppy disk, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present invention can be easily construed by programmers having ordinary skill in the art to which the present invention pertains.

While the present invention has been described with reference to the certain exemplary embodiments shown in the drawings, it will be understood by a person skilled in the art that various modifications and equivalent other embodiments may be made therefrom. Therefore, the true scope of the present invention shall be defined by the concept of the appended claims.

What is claimed is:

1. A method of actively providing information based on a position, comprising:
receiving, at a service system, identification information of a communications beacon of a plurality of beacons disposed in a subject space from a user terminal, the communications beacon communicating with the user terminal;
recognizing, at the service system, identification information of a subspace of the subject space corresponding to a user based on the identification information of the communications beacon;
specifying, at the service system, subject information corresponding to the recognized identification information of the subspace; and
transmitting, at the service system, the specified subject information to the user terminal.

2. The method according to claim 1, wherein recognizing the identification information of the subspace corresponding to the user comprises recognizing, at the service system, the identification information of the subspace corresponding to the identification information of the communications beacon based on a beacon database storing an identification information of a plurality of the subspaces and an identification information of the plurality of beacons corresponding to the plurality of the subspaces.

3. The method according to claim 2, wherein specifying the subject information comprises specifying, at the service system, the subject information based on the recognized identification information of the subspace, by referring to a space database storing space information of each of the plurality of the subspaces corresponding to the identification information of the plurality of the subspaces or the subject information corresponding to the identification information of the plurality of the subspaces.

4. The method according to claim 1, wherein the identification information of the subspace includes a uniform resource locator.

5. The method according to claim 4, wherein the uniform resource locator is mapped to a page providing space information about the subspace corresponding to the uniform resource locator.

6. The method according to claim 1, further comprising, when the user terminal communicates with one beacon of the plurality of beacons, storing at least one selected from the group consisting of identification information of the beacon, user identification information corresponding to the user terminal, and information about a communications time in a user database.

7. The method according to claim 6, further comprising, when emergency information is received, specifying, at the service system, a subject user to be influenced by the emergency information by referring to the user database, transmitting emergency-related information and the emergency information to a terminal of the specified subject user, and controlling the terminal of the subject user to output an alarm signal.

8. The method according to claim 1, wherein the communications beacon stores second subject information preset based on a position in which the communications beacon is disposed and directly transmits the second subject information to the user terminal.

9. The method according to claim 1, wherein the communications beacon stores communications history information of at least one terminal including the user terminal that communicated with the communications beacon in memory provided in the communications beacon, the communications history information including user identification information corresponding to the at least one terminal.

10. A computer program installed in a data processing device, the computer program executing the method of claim 1.

11. A system for actively providing information based on a position, the system storing:
identification information of a plurality of subspaces of a subject space; and
identification information of a beacon corresponding to each of the plurality of subspaces or space information of each of the plurality of subspaces,
wherein the identification information of the plurality of subspaces is expressed as uniform resource locators.

12. A system for actively providing information based on a position, comprising:
a communications portion receiving identification information of a communications beacon of a plurality of beacons disposed in a subject space from a user terminal, the communications beacon communicating with the user terminal;
a space recognizing portion recognizing identification information of a subspace of the subject space corresponding to a user based on the identification information of the communications beacon; and
a controlling portion specifying subject information corresponding to the recognized identification information of the subspace, and transmitting the specified subject information to the user terminal.

13. The system according to claim 12, wherein the space recognizing portion recognizes the identification information of the subspace corresponding to the identification information of the communications beacon based on a beacon database storing identification information of a plurality of the subspaces of the space and identification information of the plurality of beacons corresponding to the plurality of the subspaces.

14. The system according to claim 13, wherein the controlling portion specifies the subject information based on the recognized identification information of the subspace, by referring to a space database storing space information corresponding to the identification information of each of the plurality of the subspaces or the subject information.

15. The system according to claim 12, wherein, at every time when the user terminal communicates with one beacon of the plurality of beacons, the system stores at least one selected from the group consisting of identification information of the beacon, user identification information corresponding to the user terminal, and information about a communications time in a user database.

16. The system according to claim 15, wherein, when emergency information is received, the controlling portion specifies a subject user to be influenced by the emergency information by referring to the user database, transmitting emergency-related information and the emergency information to a terminal of the specified subject user, and controlling the terminal of the subject user to output an alarm signal.
